(19) United States
(12) Patent Application Publication
(10) Pub. No.: US 2026/0048704 A1
(43) Pub. Date: Feb. 19, 2026

(54) ALL-TERRAIN VEHICLE ACCESSORY MOUNTING DEVICE

(71) Applicant: Jon Montgomery, West Union, WV (US)

(72) Inventor: Jon Montgomery, West Union, WV (US)

(21) Appl. No.: 18/804,580

(22) Filed: Aug. 14, 2024

(51) Int. Cl. B60R 9/06

(52) U.S. Cl. CPC B60R 9/06

(57) ABSTRACT

An all-terrain vehicle accessory mounting device includes a pair of tracks that is each attachable to an all-terrain vehicle at a strategic location on the all-terrain vehicle. A pair of locks is each movably attached to a respective one of the pair of tracks. A pair of rails is each attachable to an accessory related to the all-terrain vehicle. Each of the pair of rails slidably engages a respective one of the pair of tracks for removably mounting the accessory to the all-terrain vehicle. A respective one of the pair of locks on a respective one of the pair of tracks releasably engages a respective one of the rails for securing the respective rail in the respective track. The respective rail is removable from the respective track when the respective lock is urged into the unlocking position thereby enabling the accessory to be removed from the all-terrain vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to accessory mounting devices and more particularly pertains to a new accessory mounting device for removably mounting an accessory to an all-terrain vehicle. The device includes a pair of tracks that is each attachable to an all-terrain vehicle and a pair of locks that is each movably attached to a respective track. The device includes a pair of rails that are each attachable to an accessory related to the all-terrain vehicle. Each of the rails slidably engages a respective track for mounting the accessory to the all-terrain vehicle. Additionally, each of the locks releasably engages a respective rail to releasably retain the respective rail in a respective track.

### (2) Description of Related Art Including Information Disclosed Under 37 CFR 1.97 and 1.98

The prior art relates to accessory mounting devices including a luggage box device that includes a first rigid plate which has a plurality of channels that is mountable to a motorcycle and second rigid plate which is mountable to a luggage box and which has grips that are matable to the channels in the first rigid plate for releasably mounting the luggage box to the motorcycle and a cargo retention system that includes a retention system that is attachable to a vehicle and a guide which is attached to a cargo module and the guide is matable to the retention system for securing the cargo module to the vehicle. In no instance does the prior art disclose an accessory mounting device that includes a pair of tracks that are each attachable to an all-terrain vehicle and a pair of locks that are each movably attached to a respective track and a pair of rails that are each attachable to an accessory related to the all-terrain vehicle thereby enabling each of the rails to slidably engage a respective track for removably mounting the accessory to the all-terrain vehicle.

### BRIEF SUMMARY OF THE INVENTION

An embodiment of the disclosure meets the needs presented above by generally comprising a pair of tracks that is each attachable to an all-terrain vehicle at a strategic location on the all-terrain vehicle. A pair of locks is each movably attached to a respective one of the pair of tracks. A pair of rails is each attachable to an accessory related to the all-terrain vehicle. Each of the pair of rails slidably engages a respective one of the pair of tracks for removably mounting the accessory to the all-terrain vehicle. A respective one of the pair of locks on a respective one of the pair of tracks releasably engages a respective one of the rails for securing the respective rail in the respective track. The respective rail is removable from the respective track when the respective lock is urged into the unlocking position thereby enabling the accessory to be removed from the all-terrain vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an all-terrain vehicle accessory mounting device according to an embodiment of the disclosure showing a pair of rails slidably mounted to a pair of tracks.

FIG. 2 is an exploded view of a rail and a track of an embodiment of the disclosure.

FIG. 3 is a top view of a rail and a track of an embodiment of the disclosure.

FIG. 4 is a left side view a rail and a track of an embodiment of the disclosure.

FIG. 5 is a front view of a rail and a track of an embodiment of the disclosure.

FIG. 6 is a cross sectional view taken along line 6-6 of FIG. 3 of an embodiment of the disclosure.

FIG. 7 is a cross sectional view taken along line 7-7 of FIG. 4 of an embodiment of the disclosure.

FIG. 8 is a front in-use view of an embodiment of the disclosure.

FIG. 9 is a right side in-use view of an embodiment of the disclosure.

FIG. 10 is magnified detail view taken from circle 10 of FIG. 6 of an embodiment of the disclosure.

### DETAILED DESCRIPTION OF THE INVENTION

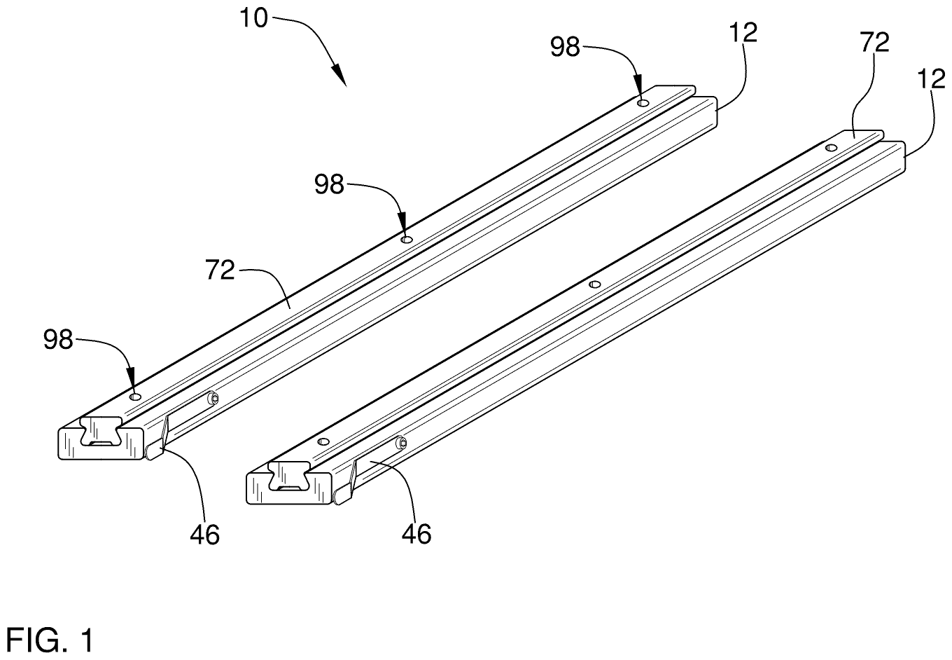

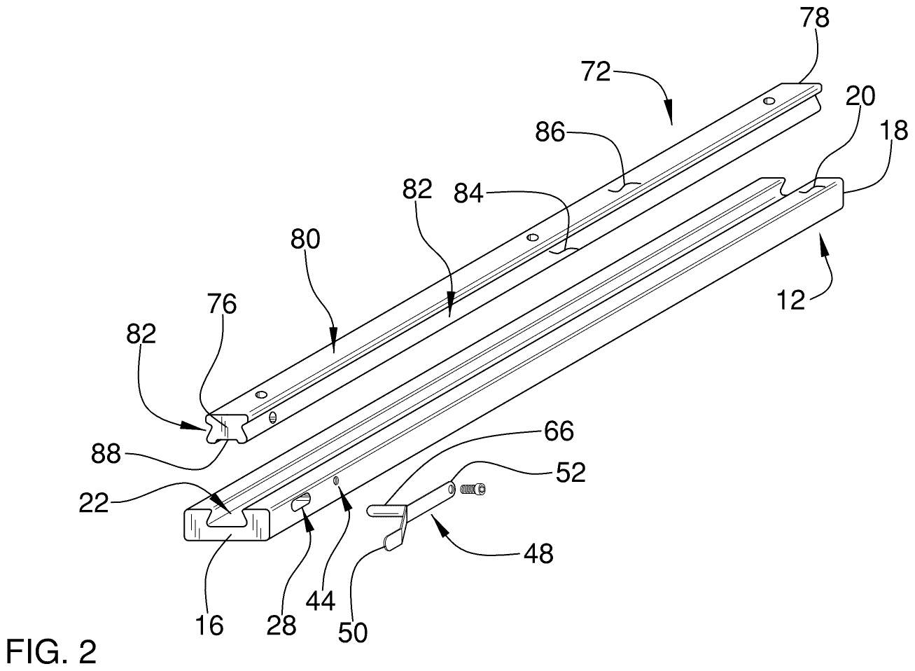

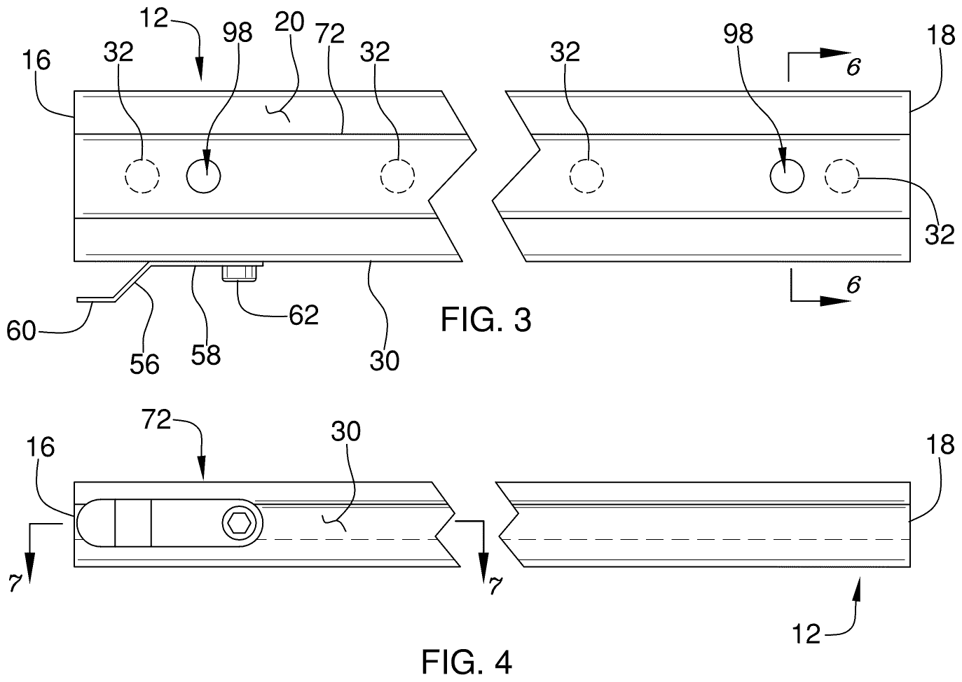

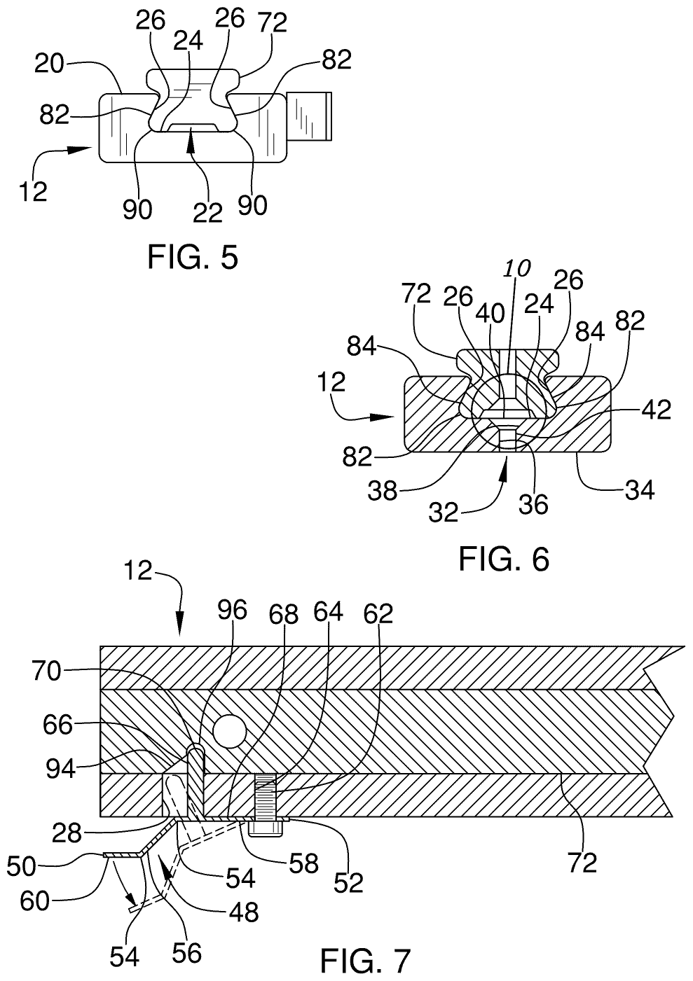

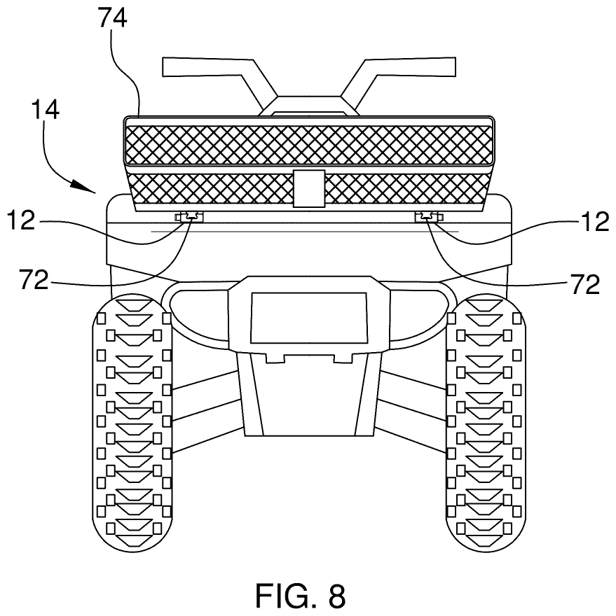

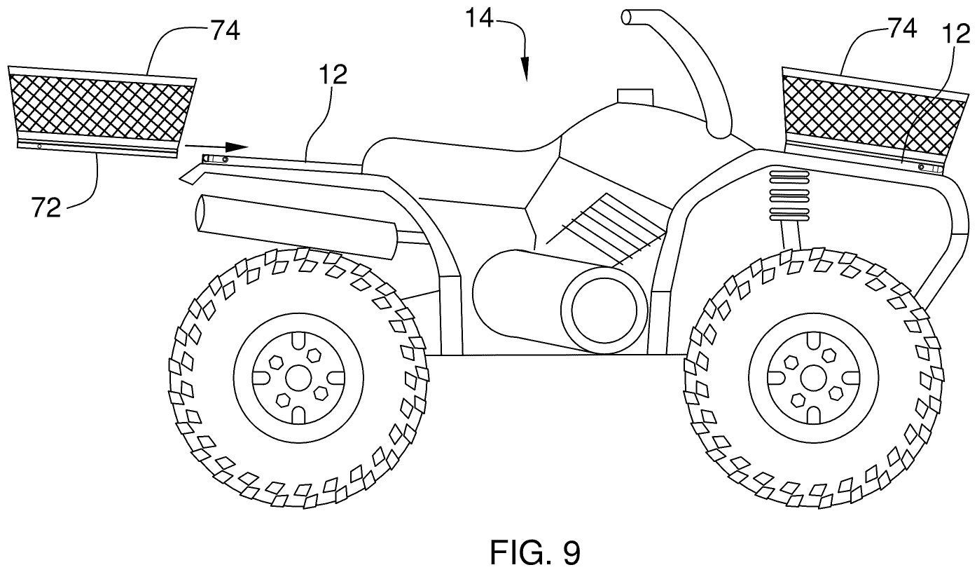

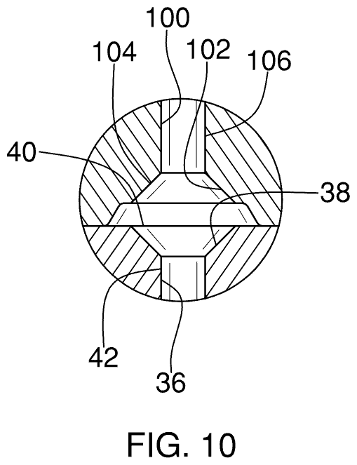

With reference now to the drawings, and in particular to FIGS. 1 through 10 thereof, a new accessory mounting device embodying the principles and concepts of an embodiment of the disclosure and generally designated by the reference numeral 10 will be described.

As best illustrated in FIGS. 1 through 10, the all-terrain vehicle accessory mounting device 10 generally comprises a pair of tracks 12 and each of the pair of tracks 12 is attachable to an all-terrain vehicle 14 at a strategic location on the all-terrain vehicle 14. The all-terrain vehicle 14 may comprise a four wheeler, a side by side or any other type of motorized all-terrain vehicle that is commonly driven off road. Each of the pair of tracks 12 has a first end 16 and a second end 18 and a top surface 20 extending between the first end 16 and the second end 18. Each of the pair of tracks 12 has a recess 22 extending downwardly in the top surface 20 and the recess 22 in each of the pair of tracks 12 extends between the first end 16 and the second end 18.

The recess 22 in each of the pair of tracks 12 has a lower bounding surface 24 which lies on a plane that is oriented parallel to the top surface 20 and the recess 22 in each of the pair of tracks 12 has a pair of lateral bounding surfaces 26. Each of the pair of lateral bounding surfaces 26 of the recess 22 in a respective track 12 extends between the top surface 20 of the respective track 12 and the lower bounding surface 24 of the recess 22 in the respective track 12. Additionally, each of the pair of lateral bounding surfaces 26 of the recess 22 in the respective track 12 angles outwardly between the top surface 20 of the respective track 12 and the lower bounding surface 24 of the recess 22 in the respective track 12. Each of the pair of tracks 12 has a slot 28 extending through a lateral surface 30 of a respective track 12 and intersecting the recess 22 in the respective track 12. The slot 28 in each of the pair of tracks 12 is located closer to the first end 16 than the second end 18 and the slot 28 in each of the pair of tracks 12 is elongated along an axis extending between the first end 16 and the second end 18 such that the slot 28 in each of the pair of tracks 12 has an ovoid shape.

Each of the pair of tracks 12 has a plurality of fastener holes 32 which each extends through the lower bounding surface 24 of the recess 22 in a respective track 12 and a bottom surface 34 of the respective track 12. Each of the plurality of fastener holes 32 has a first portion 36 extending from the bottom surface 34 of a respective track 12 toward the lower bounding surface 24 of the recess 22 in the respective track 12. Additionally, each of the plurality of fastener holes 32 has a second portion 38 which angles outwardly between the first portion 36 and the lower bounding surface 24 of the recess 22 in the respective track 12. Furthermore, the second portion 38 of each of the plurality of fastener holes 32 accommodates a head 40 of a fastener 42 which is extended through a respective fastener hole 32 to fasten the respective track 12 to the all-terrain vehicle 14. The plurality of fastener holes 32 in each of the pair of tracks 12 is evenly spaced apart from each other and is distributed between the first end 16 and the second end 18 of a respective track 12. Additionally, each of the pair of tracks 12 has a fastener well 44 extending into the lateral surface 30 of a respective track 12 and the fastener well 44 in each of the pair of tracks 12 is positioned closer to the slot 28 in the respective track 12 than the second end 18 of the respective track 12.

A pair of locks 46 is provided and each of the pair of locks 46 is movably attached to a respective one of the pair of tracks 12. Each of the pair of locks 46 is biased into a locking position and each of the pair of locks 46 is urgeable into an unlocking position. Each of the pair of locks 46 comprises a member 48 which has a front end 50 and a rear end 52. The member 48 has a pair of bends 54 which are spaced apart from each other and which are distributed between the front end 50 and the rear end 52. The pair of bends 54 defines a middle portion 56 of the member 48 which is oriented at an angle with each of a rear portion 58 of the member 48 and a front portion 60 of the member 48. The rear portion 58 is associated with the rear end 52 and the front portion 60 is associated with the front end 50. Furthermore, the rear portion 58 lies on a plane which is oriented parallel with the front portion 60.

The rear portion 58 lies against the lateral surface 30 of a respective one of the pair of tracks 12 having an intersection between the rear portion 58 and the middle portion 56 being aligned with the slot 28 in the respective track 12. In this way the front portion 60 is spaced from the lateral surface 30 of the respective track 12 thereby enabling the front portion 60 to be gripped. The rear portion 58 of the member 48 lies against the lateral surface 30 of the respective track 12 and the rear portion 58 of the member 48 angles away from the lateral surface 30 of the respective track 12 when the front portion 60 is gripped and pulled away from the lateral surface 30. Furthermore, the member 48 is comprised of a resiliently flexible material, including but not being limited to a metal alloy or plastic, thereby enabling the member 48 to be biased to have the rear portion 58 lie against the lateral surface 30 of the respective track 12.

Each of the pair of locks 46 includes a fastener 62, such as a screw or other type of threaded fastener, which extends through the rear portion 58 and extends into the fastener well 44 in the lateral surface 30 of the respective track 12. The fastener 62 threadably engages a bounding surface 64 of the fastener well 44 for attaching the member 48 to the lateral surface 30 of the respective track 12. Additionally, the fastener 62 is located adjacent to the rear end 52 of the member 48. Each of the pair of locks 46 includes a finger 66 which is attached to and extends away from a rear surface 68 of the rear portion 58 of the member 48. The finger 66 is located adjacent to the intersection between the rear portion 58 and the middle portion 56 thereby enabling the finger 66 to extend through the slot 28 in the respective track 12 such that a distal end 70 of the finger 66 is positioned in the recess 22 in the respective track 12. Furthermore, the distal end 70 of the finger 66 is displaced from the recess 22 in the respective track 12 when the front portion 60 of the member 48 is gripped and pulled away from the lateral surface 30 of the respective track 12.

A pair of rails 72 is provided and each of the pair of rails 72 is attachable to an accessory 74 related to the all-terrain vehicle 14. The accessory 74 may be a storage basket, a rack for holding tools, or any other type of aftermarket accessory that is commonly attached to all-terrain vehicles. Each of the pair of rails 72 slidably engages a respective one of the pair of tracks 12 for removably mounting the accessory 74 to the all-terrain vehicle 14. Additionally, a respective one of the pair of locks 46 on a respective one of the pair of tracks 12 releasably engages a respective one of the rails 72 when the respective rail 72 is slidably engaged to the respective track 12. In this way the respective rail 72 is secured in the respective track 12 thereby enabling the accessory 74 to be secured to the all-terrain vehicle 14. Conversely, the respective rail 72 is removable from the respective track 12 when the respective lock 46 is urged into the unlocking position thereby enabling the accessory 74 to be removed from the all-terrain vehicle 14.

Each of the pair of rails 72 has a primary end 76 and a secondary end 78 and each of the pair of rails 72 is elongated between the primary end 76 and the secondary end 78. Each of the pair of rails 72 has a head 80 and a pair of feet 82 each extending downwardly from and angling outwardly from the head 80 in opposite directions from each other. An outwardly facing surface 84 of each of the pair of feet 82 on a respective one of the pair of rails 72 conforms to a respective one of the lateral bounding surfaces 26 of the recess 22 in the respective track 12 when the respective rail 72 is slid into the recess 22 in the respective track 12. In this way the respective rail 72 is secured in the recess 22 in the respective track 12 having an upper surface 86 of the head 80 on the respective rail 72 being exposed in the respective track 12.

Each of the pair of rails 72 has a bottom surface 88 which extends between the pair of feet 82 of a respective rail 72 having the bottom surface 88 of the respective rail 72 being spaced upwardly from a distal end 90 of each of the pair of feet 82 of the respective rail 72. Each of the pair of rails 72 has a lock well 92 which extends into the outwardly facing surface 84 of a respective one of the pair of feet 82 on a respective rail 72. The lock well 92 in the respective rail 72 is positioned closer to the primary end 76 of the respective rail 72 than the secondary end 78 of the respective rail 72. Additionally, the lock well 92 in the respective rail 72 has a sloped portion 94 which angles inwardly between the outwardly facing surface 84 of the respective foot 82 of the respective rail 72 and a concave portion 96 of the lock well 92 in the respective rail 72. The lock well 92 in the respective rail 72 is aligned with the slot 28 in the respective track 12 when the respective rail 72 is fully seated in the respective track 12. In this way the finger 66 of the lock on the respective track 12 can extend into the concave portion 96 of the lock well 92 in the respective rail 72 for securing the respective rail 72 in the respective track 12. The sloped portion 94 of the lock well 92 in the respective rail 72 enables the finger 66 of the lock on the respective track 12 to slide along the sloped portion 94 when the respective rail 72 is slid into the respective track 12 until the respective rail 72 is fully seated in the respective track 12. In this way the finger 66 of the respective lock 46 on the respective track 12 can be seated in the concave portion 96 of the lock well 92 in the respective rail 72. Conversely, the finger 66 of the lock on the respective track 12 is displaced from the concave portion 96 of the lock well 92 in the respective rail 72 when the front portion 60 of the member 48 of the lock on the respective track 12 is pulled away from the lateral surface 30 of the respective track 12 thereby enabling the respective rail 72 to be removed from the respective track 12.

Each of the pair of rails 72 has a plurality of fastener holes 98 each extending between the upper surface 86 of the head 80 of a respective rail 72 and the bottom surface 88 of the respective rail 72. Each of the plurality of fastener holes 98 in the pair of rails 72 has a primary portion 100 extending from the upper surface 86 of the head 80 of the respective rail 72 toward the bottom surface 88 of the respective rail 72. Additionally, each of the plurality of fastener holes 98 in the pair of rails 72 has a secondary portion 102 which angles outwardly between the primary portion 100 and the bottom surface 88 of the respective rail 72 to accommodate a head 104 of a fastener 106 which attaches the respective rail 72 to the accessory 74.

In use, each of the pair of tracks 12 is mounted to the all-terrain vehicle 14 at a strategic location chosen by a user. Each of the pair of rails 72 is attached to the accessory 74 and each of the pair of rails 72 is spaced apart from each other a distance that matches the distance between the pair of tracks 12. In this way accessory 74 can be mounted to the all-terrain vehicle 14 by sliding each of the pair of rails 72 into the respective track 12. The finger 66 on each of the pair of locks 46 extends into the concave portion 96 of the lock well 92 in a respective rail 72 to secure the respective rail 72 in the respective track 12. The front portion 60 of the member 48 of each of the locks 46 is pulled away from the respective track 12 to displace the finger 66 of the pair of locks 46 from the concave portion 96 of the lock well 92 in the respective rail 72. In this way the pair of rails 72 can be removed from the pair of tracks 12 thereby removing the accessory 74 from the all-terrain vehicle 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An all-terrain vehicle accessory mounting device for removably mounting an accessory to an all-terrain vehicle, said device comprising:
a pair of tracks, each of said pair of tracks being attachable to an all-terrain vehicle at a strategic location on said all-terrain vehicle;
a pair of locks, each of said pair of locks being movably attached to a respective one of said pair of tracks, each of said pair of locks being biased into a locking position, each of said pair of locks being urgeable into an unlocking position; and
a pair of rails, each of said pair of rails being attachable to an accessory related to said all-terrain vehicle, each of said pair of rails slidably engaging a respective one of said pair of tracks for removably mounting said accessory to said all-terrain vehicle, a respective one of said pair of locks on a respective one of said pair of tracks releasably engaging a respective one of said rails when said respective rail is slidably engaged to said respective track for securing said respective rail in said respective track thereby enabling said accessory to be secured to said all-terrain vehicle, said respective rail being removable from said respective track when said respective lock is urged into said unlocking position thereby enabling said accessory to be removed from said all-terrain vehicle.

2. The device according to claim 1, wherein:
each of said pair of tracks having a first end and a second end and a top surface extending between said first end and said second end;
each of said pair of tracks has a recess extending downwardly in said top surface;
said recess in each of said pair of tracks extends between said first end and said second end;
said recess in each of said pair of tracks has a lower bounding surface lying on a plane being oriented parallel to said top surface;
said recess in each of said pair of tracks has a pair of lateral bounding surfaces;
each of said pair of lateral bounding surfaces of said recess in a respective track extends between said top surface of said respective track and said lower bounding surface of said recess in said respective track;
each of said pair of lateral bounding surfaces of said recess in said respective track angles outwardly between said top surface of said respective track and said lower bounding surface of said recess in said respective track;
each of said pair of tracks has a slot extending through a lateral surface of a respective track and intersects said recess in said respective track;
said slot in each of said pair of tracks is located closer to said first end than said second end; and
said slot in each of said pair of tracks is elongated along an axis extending between said first end and said second end such that said slot in each of said pair of tracks has an ovoid shape.

3. The device according to claim 2, wherein:
each of said pair of tracks has a plurality of fastener holes which each extends through said lower bounding surface of said recess in a respective track and a bottom surface of said respective track;
each of said plurality of fastener holes has a first portion extending from said bottom surface of a respective track toward said lower bounding surface of said recess in said respective track;
each of said plurality of fastener holes has a second portion which angles outwardly between said first portion and said lower bounding surface of said recess in said respective track thereby enabling said second portion of each of said plurality of fastener holes to accommodate a head of a fastener which is extended through a respective fastener hole to fasten said respective track to said all-terrain vehicle; and
said plurality of fastener holes in each of said pair of tracks is evenly spaced apart from each other and is distributed between said first end and said second end of a respective track.

4. The device according to claim 2, wherein:
each of said pair of tracks has a fastener well extending into said lateral surface of a respective track; and
said fastener well in each of said pair of tracks is positioned closer to said slot in said respective track than said second end of said respective track.

5. The device according to claim 4, wherein:
each of said pair of locks includes a member having a front end and a rear end;
said member has a pair of bends being spaced apart from each other and being distributed between said front end and said rear end to define a middle portion of said member which is oriented at an angle with each of a rear portion of said member and a front portion of said member;
said rear portion is associated with said rear end;
said front portion is associated with said front end;
said rear portion lies on a plane being oriented parallel with said front portion;
said rear portion lies against said lateral surface of a respective one of said pair of tracks having an intersection between said rear portion and said middle portion being aligned with said slot in said respective track such that said front portion is spaced from said lateral surface of said respective track thereby enabling said front portion to be gripped;
said rear portion of said member lies against said lateral surface of said respective track;
said rear portion of said member angles away from said lateral surface of said respective track when said front portion is gripped and pulled away from said lateral surface;
said member is comprised of a resiliently flexible material thereby enabling said member to be biased to have said rear portion lying against said lateral surface of said respective track;
each of said pair of locks includes a fastener extending through said rear portion and extending into said fastener well in said lateral surface of said respective track;
said fastener threadably engages a bounding surface of said fastener well for attaching said member to said lateral surface of said respective track;
said fastener is located adjacent to said rear end of said member.

6. The device according to claim 5, wherein:
each of said pair of locks includes a finger being attached to and extending away from a rear surface of said rear portion of said member;
said finger is located adjacent to said intersection between said rear portion and said middle portion thereby enabling said finger to extend through said slot in said respective track such that said distal end of said finger is positioned in said recess in said respective track; and
said distal end of said finger is displaced from said recess in said respective track when said front portion of said member is gripped and pulled away from said lateral surface of said respective track.

7. The device according to claim 2, wherein:
each of said pair of rails has a primary end and a secondary end;
each of said pair of rails is elongated between said primary end and said secondary end;
each of said pair of rails has a head and a pair of feet each extending downwardly from and angling outwardly from said head in opposite directions from each other;
an outwardly facing surface of each of said pair of feet on a respective one of said pair of rails conforms to a respective one of said lateral bounding surfaces of said recess in said respective track when said respective rail is slid into said recess in said respective track for securing said respective rail in said recess in said respective track having an upper surface of said head on said respective rail being exposed in said respective track;
each of said pair of rails having a bottom surface which extends between said pair of feet of a respective rail having said bottom surface of said respective rail being spaced upwardly from a distal end of each of said pair of feet of said respective rail;
each of said pair of rails has a lock well extending into said outwardly facing surface of a respective one of said pair of feet on a respective rail; and
said lock well in said respective rail is positioned closer to said primary end of said respective rail than said secondary end of said respective rail.

8. The device according to claim 7, wherein:
each of said pair of locks includes member having a front portion and a finger which is attached to said member;
said lock well in said respective rail has a sloped portion which angles inwardly between said outwardly facing surface of said respective foot of said respective rail and a concave portion of said lock well in said respective rail;
said lock well in said respective rail is aligned with said slot in said respective track when said respective rail is fully seated in said respective track thereby enabling said finger of said lock on said respective track to extend into said concave portion of said lock well in said respective rail for securing said respective rail in said respective track;
said sloped portion of said lock well in said respective rail enables said finger of said lock on said respective track to slide along said sloped portion when said respective rail is slid into said respective track until said respective rail is fully seated in said respective track thereby enabling said finger of said respective lock on said respective track to be seated in said concave portion of said lock well in said respective rail; and
said finger of said lock on said respective track is displaced from said concave portion of said lock well in said respective rail when said front portion of said member of said lock on said respective track is pulled away from said lateral surface of said respective track thereby enabling said respective rail to be removed from said respective track.

9. The device according to claim 7, wherein:
each of said pair of rails has a plurality of fastener holes extending between said upper surface of said head of a respective rail and said bottom surface of said respective rail;
each of said plurality of fastener holes in said pair of rails has a primary portion extending from said upper surface of said head of said respective rail toward said bottom surface of said respective rail; and
each of said plurality of fastener holes in said pair of rails has a secondary portion which angles outwardly between said primary portion and said bottom surface of said respective rail to accommodate a head of a fastener which attaches said respective rail to said accessory.

10. An all-terrain vehicle accessory mounting device for removably mounting an accessory to an all-terrain vehicle, said device comprising:
a pair of tracks, each of said pair of tracks being attachable to an all-terrain vehicle at a strategic location on said all-terrain vehicle, each of said pair of tracks having a first end and a second end and a top surface extending between said first end and said second end, each of said pair of tracks having a recess extending downwardly in said top surface, said recess in each of said pair of tracks extending between said first end and said second end, said recess in each of said pair of tracks having a lower bounding surface lying on a plane being oriented parallel to said top surface, said recess in each of said pair of tracks having a pair of lateral bounding surfaces, each of said pair of lateral bounding surfaces of said recess in a respective track extending between said top surface of said respective track and said lower bounding surface of said recess in said respective track, each of said pair of lateral bounding surfaces of said recess in said respective track angling outwardly between said top surface of said respective track and said lower bounding surface of said recess in said respective track, each of said pair of tracks having a slot extending through a lateral surface of a respective track and intersecting said recess in said respective track, said slot in each of said pair of tracks being located closer to said first end than said second end, said slot in each of said pair of tracks being elongated along an axis extending between said first end and said second end such that said slot in each of said pair of tracks has an ovoid shape, each of said pair of tracks having a plurality of fastener holes which each extends through said lower bounding surface of said recess in a respective track and a bottom surface of said respective track, each of said plurality of fastener holes having a first portion extending from said bottom surface of a respective track toward said lower bounding surface of said recess in said respective track, each of said plurality of fastener holes having a second portion which angles outwardly between said first portion and said lower bounding surface of said recess in said respective track thereby enabling said second portion of each of said plurality of fastener holes to accommodate a head of a fastener which is extended through a respective fastener hole to fasten said respective track to said all-terrain vehicle, said plurality of fastener holes in each of said pair of tracks being evenly spaced apart from each other and being distributed between said first end and said second end of a respective track, each of said pair of tracks having a fastener well extending into said lateral surface of a respective track, said fastener well in each of said pair of tracks being positioned closer to said slot in said respective track than said second end of said respective track;
a pair of locks, each of said pair of locks being movably attached to a respective one of said pair of tracks, each of said pair of locks being biased into a locking position, each of said pair of locks being urgeable into an unlocking position, each of said pair of locks comprising:
a member having a front end and a rear end, said member having a pair of bends being spaced apart from each other and being distributed between said front end and said rear end to define a middle portion of said member which is oriented at an angle with each of a rear portion of said member and a front portion of said member, said rear portion being associated with said rear end, said front portion being associated with said front end, said rear portion lying on a plane being oriented parallel with said front portion, said rear portion lying against said lateral surface of a respective one of said pair of tracks having an intersection between said rear portion and said middle portion being aligned with said slot in said respective track such that said front portion is spaced from said lateral surface of said respective track thereby enabling said front portion to be gripped, said rear portion of said member lying against said lateral surface of said respective track, said rear portion of said member angling away from said lateral surface of said respective track when said front portion is gripped and pulled away from said lateral surface, said member being comprised of a resiliently flexible material thereby enabling said member to be biased to have said rear portion lying against said lateral surface of said respective track;
a fastener extending through said rear portion and extending into said fastener well in said lateral surface of said respective track, said fastener threadably engaging a bounding surface of said fastener well for attaching said member to said lateral surface of said respective track, said fastener being located adjacent to said rear end of said member; and
a finger being attached to and extending away from a rear surface of said rear portion of said member, said finger being located adjacent to said intersection between said rear portion and said middle portion thereby enabling said finger to extend through said slot in said respective track such that said distal end of said finger is positioned in said recess in said respective track, said distal end of said finger being displaced from said recess in said respective track when said front portion of said member is gripped and pulled away from said lateral surface of said respective track; and
a pair of rails, each of said pair of rails being attachable to an accessory related to said all-terrain vehicle, each of said pair of rails slidably engaging a respective one of said pair of tracks for removably mounting said accessory to said all-terrain vehicle, a respective one of said pair of locks on a respective one of said pair of tracks releasably engaging a respective one of said rails when said respective rail is slidably engaged to said respective track for securing said respective rail in said respective track thereby enabling said accessory to be secured to said all-terrain vehicle, said respective rail being removable from said respective track when said respective lock is urged into said unlocking position thereby enabling said accessory to be removed from said all-terrain vehicle, each of said pair of rails having a primary end and a secondary end, each of said pair of rails being elongated between said primary end and said secondary end, each of said pair of rails having a head and a pair of feet each extending downwardly from and angling outwardly from said head in opposite directions from each other, an outwardly facing surface of each of said pair of feet on a respective one of said pair of rails conforming to a respective one of said lateral bounding surfaces of said recess in said respective track when said respective rail is slid into said recess in said respective track for securing said respective rail in said recess in said respective track having an upper surface of said head on said respective rail being exposed in said respective track, each of said pair of rails having a bottom surface which extends between said pair of feet of a respective rail having said bottom surface of said respective rail being spaced upwardly from a distal end of each of said pair of feet of said respective rail, each of said pair of rails having a lock well extending into said outwardly facing surface of a respective one of said pair of feet on a respective rail, said lock well in said respective rail being positioned closer to said primary end of said respective rail than said secondary end of said respective rail, said lock well in said respective rail having a sloped portion which angles inwardly between said outwardly facing surface of said respective foot of said respective rail and a concave portion of said lock well in said respective rail, said lock well in said respective rail being aligned with said slot in said respective track when said respective rail is fully seated in said respective track thereby enabling said finger of said lock on said respective track to extend into said concave portion of said lock well in said respective rail for securing said respective rail in said respective track, said sloped portion of said lock well in said respective rail enabling said finger of said lock on said respective track to slide along said sloped portion when said respective rail is slid into said respective track until said respective rail is fully seated in said respective track thereby enabling said finger of said respective lock on said respective track to be seated in said concave portion of said lock well in said respective rail, said finger of said lock on said respective track being displaced from said concave portion of said lock well in said respective rail when said front portion of said member of said lock on said respective track is pulled away from said lateral surface of said respective track thereby enabling said respective rail to be removed from said respective track, each of said pair of rails having a plurality of fastener holes extending between said upper surface of said head of a respective rail and said bottom surface of said respective rail, each of said plurality of fastener holes in said pair of rails having a primary portion extending from said upper surface of said head of said respective rail toward said bottom surface of said respective rail, each of said plurality of fastener holes in said pair of rails having a secondary portion which angles outwardly between said primary portion and said bottom surface of said respective rail to accommodate a head of a fastener which attaches said respective rail to said accessory.
